(19) United States
(12) Patent Application Publication
(10) Pub. No.: US 2022/0327757 A1
(43) Pub. Date: Oct. 13, 2022

(54) METHOD AND APPARATUS FOR GENERATING DYNAMIC VIDEO OF CHARACTER, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Ruifeng DENG, Beijing (CN); Tianwei LIN, Beijing (CN); Fu LI, Beijing (CN)

(21) Appl. No.: 17/849,225

(22) Filed: Jun. 24, 2022

(30) Foreign Application Priority Data
Jul. 19, 2021 (CN) 202110813685.1

(51) Int. Cl. G06T 13/40; G06T 7/12; G06T 7/181; G06T 7/73; G06T 3/60

(52) U.S. Cl. CPC G06T 13/40; G06T 7/12; G06T 7/181; G06T 7/73; G06T 3/60; G06T 2207/30196; G06T 2207/10016; G06T 2207/20021

(57) ABSTRACT

An apparatus, an electronic device, and a storage medium may implement a method for generating a dynamic video of a character. The method includes: identifying a character contour area from a first picture containing a character image; acquiring a plurality of sampling points in the first picture based on the character contour area, and dividing the first picture into a plurality of triangles by each of the sampling points; deforming at least a portion of the plurality of triangles in the first picture to obtain a second picture; and acquiring at least one intermediate picture between the first picture and the second picture, and generating the dynamic video of the character comprising the first picture, the second picture and the at least one intermediate picture.

### CROSS-REFERENCE TO RELATED APPLICATIONS

The present application claims the priority of Chinese Patent Application No. 202110813685.1, titled “METHOD AND APPARATUS FOR GENERATING DYNAMIC VIDEO OF CHARACTER, ELECTRONIC DEVICE AND STORAGE MEDIUM”, filed on Jul. 19, 2021, the content of which is incorporated herein by reference in its entirety.

### TECHNICAL FIELD

The present disclosure relates to the field of artificial intelligence, in particular to computer vision and deep learning technologies, which may specifically be used in image processing scenarios.

### BACKGROUND

In some application scenarios, it is necessary to generate a dynamic video of a character that can reflect pose changes of the character based on a basic picture containing a character image. In existing technologies, image processing software (such as PS) is generally used to deform the character image in the basic picture to obtain a plurality of pictures with different poses of the character. The basic picture and the plurality of pictures obtained based on the basic picture are used as a plurality of video frames of the dynamic video of the character. The above method for generating a dynamic video of a character based on the basic picture requires more manual participation, and a video generation efficiency is low.

### SUMMARY

The present disclosure provides a method and apparatus for generating a dynamic video of a character, an electronic device and a storage medium.

According to a first aspect of the present disclosure, a method for generating a dynamic video of a character is provided, the method including:

identifying a character contour area in a first picture containing a character image;

acquiring a plurality of sampling points in the first picture based on the character contour area, and dividing the first picture into a plurality of triangles by the sampling points;

deforming at least a portion of the plurality of triangles in the first picture to obtain a second picture; and

acquiring at least one intermediate picture between the first picture and the second picture, and generating the dynamic video of the character including the first picture, the second picture and the at least one intermediate picture.

According to a second aspect of the present disclosure, an apparatus for generating a dynamic video of a character is provided, the apparatus including:

a contour identifying module, configured to identify a character contour area in a first picture containing a character image;

an area dividing module, configured to acquire a plurality of sampling points in the first picture based on the character contour area, and divide the first picture into a plurality of triangles by the sampling points;

a picture acquiring module, configured to deform at least a portion of the plurality of triangles in the first picture to obtain a second picture; and

a video generating module, configured to acquire at least one intermediate picture between the first picture and the second picture, and generate the dynamic video of the character including the first picture, the second picture and the at least one intermediate picture.

According to a third aspect of the present disclosure, an electronic device is provided, including:

at least one processor; and

a memory communicatively connected to the at least one processor; wherein,

the memory stores instructions executable by the at least one processor, and the instructions, when executed by the at least one processor, cause the at least one processor to perform the above method for generating a dynamic video of a character.

According to a fourth aspect of the present disclosure, it is provided non-transitory computer readable storage medium storing computer instructions, wherein, the computer instructions are used to cause the computer to perform the above method for generating a dynamic video of a character.

According to a fourth aspect of the present disclosure, a computer program product is provided, including a computer program, the computer program, when executed by a processor, implements the above method for generating a dynamic video of a character.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The accompanying drawings are used for better understanding of the present solution, and do not constitute a limitation to the present disclosure, in which:

FIG. 1 shows a schematic flowchart of a method for generating a dynamic video of a character provided by an embodiment of the present disclosure;

FIG. 2 shows an exemplary first picture provided by an embodiment of the present disclosure;

FIG. 3 shows a schematic diagram of a character contour area identified in a first picture provided by an embodiment of the present disclosure;

FIG. 4 shows a schematic flowchart of a method for generating a dynamic video of a character provided by an embodiment of the present disclosure;

FIG. 5 shows an exemplary schematic distribution diagram of some human body key points provided by an embodiment of the present disclosure;

FIG. 6 shows a schematic flowchart of a method for determining dynamic point sampling provided by an embodiment of the present disclosure;

FIG. 7 shows a schematic diagram of a character expansion contour area determined in a first picture provided by an embodiment of the present disclosure;

FIG. 8 shows a schematic diagram of a character erosion contour area determined in a first picture provided by an embodiment of the present disclosure;

FIG. 9 shows an exemplary schematic distribution diagram of triangles in a first picture provided by an embodiment of the present disclosure;

FIG. 10 shows a schematic structural diagram of an apparatus for generating a dynamic video of a character provided by an embodiment of the present disclosure; and

FIG. 11 shows a schematic block diagram of an example electronic device that may be used to implement the method for generating a dynamic video of a character provided by an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

In some application scenarios, it is necessary to generate a dynamic video of a character that can reflect pose changes of the character pose based on a basic picture containing a character image. In existing technologies, image processing software (such as PS) is generally used to deform the character image in the basic picture to obtain a plurality of pictures with different poses of the character. The basic picture and the plurality of pictures obtained based on the basic picture are used as a plurality of video frames of the dynamic video of the character. The above method for generating a dynamic video of a character based on the basic picture requires more manual participation, and the video generation efficiency is low.

A method and apparatus for generating a dynamic video of a character, an electronic device and a storage medium provided by the embodiments of the present disclosure are intended to solve at least one of the above technical problems in the existing technologies.

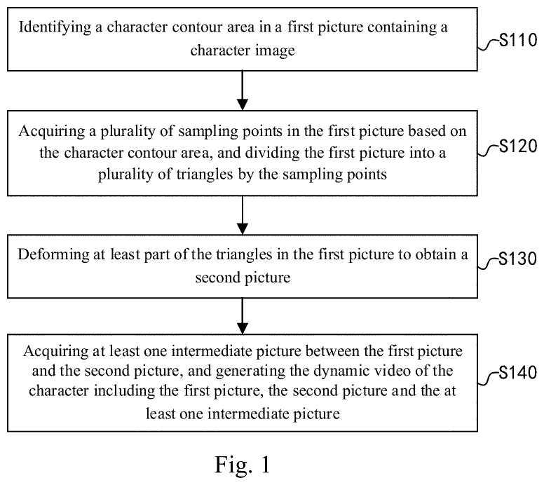

FIG. 1 shows a schematic flowchart of a method for generating a dynamic video of a character provided by an embodiment of the present disclosure, as shown in FIG. 1, the method may mainly include the following steps.

S110: identifying a character contour area in a first picture containing a character image.

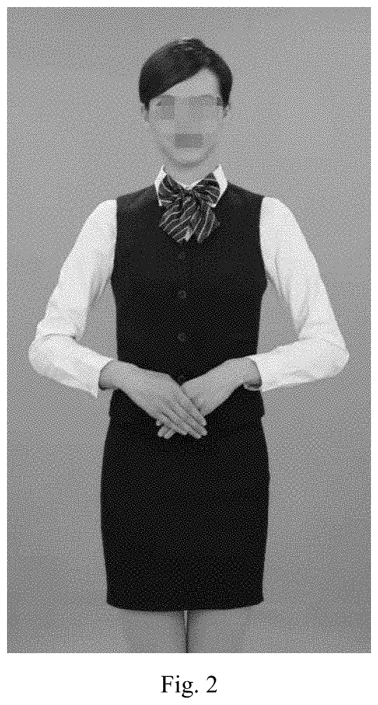

FIG. 2 shows an exemplary first picture provided by an embodiment of the present disclosure. As shown in FIG. 2, the character image in the first picture may be a real-person image. Of course, the character image in the first picture may also be a created virtual-character image. It should be noted here that when the character image in the first picture is a real-person image, relevant authorization (such as authorization of the person in the picture) needs to be obtained, and the method in an embodiment of the present disclosure does not need to acquire privacy information, such as iris, lip lines, or fingerprints, of the person himself/herself in the picture.

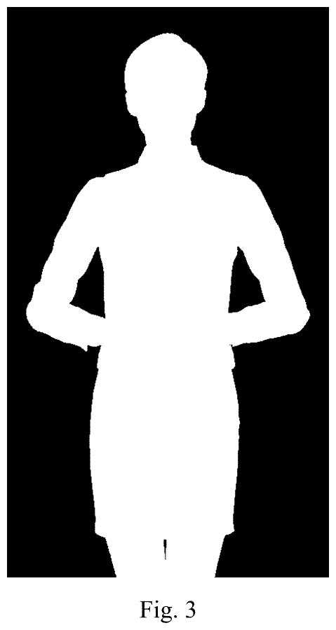

It may be understood that the first picture includes a background area and the character contour area, and this step is required to identify the character contour area in the first picture in the first picture. FIG. 3 shows a schematic diagram of a character contour area identified in a first picture provided by an embodiment of the present disclosure. In FIG. 3, a black area represents the background area, and a white area represents the character contour area.

S120: acquiring a plurality of sampling points in the first picture based on the character contour area, and dividing the first picture into a plurality of triangles by the sampling points.

In this step, the plurality of sampling points may be acquired in the first picture based on the character contour area according to a preset point-sampling method, and the plurality of sampling points may include sampling points inside the character contour area and sampling points outside the character contour area. Then, based on the plurality of sampling points, a triangulation algorithm may be used to divide the first picture into the plurality of triangles. Of course, other algorithms may also be used to divide the first image into the plurality of triangles, which will not be listed here.

Optionally, in an embodiment of the present disclosure, the plurality of sampling points include fixed sampling points and dynamic sampling points. In this step, a dynamic-point sampling range corresponding to the character contour area may be determined, and a plurality of the dynamic sampling points may be acquired within the dynamic-point sampling range, and a plurality of the fixed sampling points may be acquired outside the dynamic-point sampling range. Here, the dynamic-point sampling range includes at least the character contour area, and any one of the dynamic sampling points is not on an edge of the character contour area.

S130: deforming at least a portion of the plurality of triangles in the first picture to obtain a second picture.

In an embodiment of the present disclosure, three vertices of each triangle are all sampling points. In this step, at least a portion of the plurality of triangles may be deformed by changing a position of at least one sampling point, and the first picture with the at least part of the triangles being deformed is defined as the second picture. It may be understood that since at least a portion of the triangles in the second picture are different from corresponding triangles in the first picture, a pose of the character in the second picture is different from the pose of the character in the first picture.

Optionally, in this step, a preset type of human body key point may be identified in the first picture. At least one of the sampling points may be rotated by a preset angle based on at least one type of the human body key point to deform at least a portion of the plurality of triangles in the first picture.

S140: acquiring at least one intermediate picture between the first picture and the second picture, and generating the dynamic video of the character including the first picture, the second picture and the at least one intermediate picture.

As described above, the pose of the character in the second picture is different from the pose of the character in the first picture, and at least one intermediate changed pose of the two character poses may be estimated according to the pose of the character in the second picture and the pose of the character in the first picture, then to generate the intermediate picture containing the intermediate changed pose.

In this step, after the at least one intermediate picture is obtained, the first picture, the second picture and the at least one intermediate picture may be used as a set of video frames to obtain the dynamic video of the character. It may be understood that the first picture, the at least one intermediate picture and the second picture may be displayed in sequence during playing the dynamic video of the character, so as to smoothly display a pose change process of the character image.

Optionally, in this step, video frame insertion may be performed based on the first picture and the second picture to acquire the at least one intermediate picture between the first picture and the second picture. It should be noted here that a video frame insertion algorithm used in this step may be determined according to actual needs. For example, the DAIN algorithm may be used to complete the pose change process of the character in the first picture and the second picture to obtain the at least one intermediate picture. The intermediate picture may be quickly acquired by means of video frame insertion, and the intermediate picture may be used to complete the pose change process of the character in the first picture and the second picture, so as to ensure continuity of the dynamic video of the character.

In the method for generating a dynamic video of a character provided by an embodiment of the present disclosure, a second picture with a pose different from the pose of the character in the first picture is first generated, and then an intermediate picture between the first picture and the second picture is generated to obtain a dynamic video of the character. The above process of generating a dynamic video of a character substantially does not require human participation, which can save costs and improve the video generation efficiency.

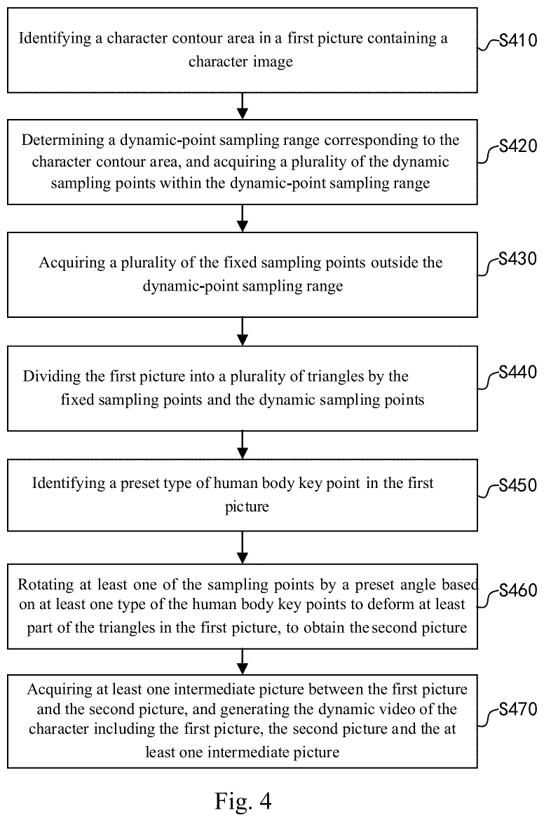

FIG. 4 shows a schematic flowchart of a method for generating a dynamic video of a character provided by an embodiment of the present disclosure, as shown in FIG. 4, the method may mainly include the following steps.

S410: identifying a character contour area in a first picture containing a character image.

Here, description of step S410 may refer to the description of step S110, and detailed description thereof will be omitted.

S420: determining a dynamic-point sampling range corresponding to the character contour area, and acquiring a plurality of the dynamic sampling points within the dynamic-point sampling range.

As described above, in an embodiment of the present disclosure, it is necessary to acquire a plurality of sampling points in the first picture based on the character contour area, and the plurality of sampling points include fixed sampling points and dynamic sampling points. In this step, the dynamic-point sampling range may be first determined, then the dynamic sampling points may be acquired within the dynamic-point sampling range. Here, a corresponding dynamic-point sampling range may be determined based on a position range of the character contour area in the first picture, and the dynamic-point sampling range includes at least the character contour area.

When acquiring the dynamic sampling points in the dynamic-point sampling range, it should be ensured that any one of the dynamic sampling points is not on the edge of the character contour area. In particular, as shown in FIG. 3, the edge of the character contour area is an interface between the black area and the white area in FIG. 3, and none of the dynamic sampling points is on the interface.

In an embodiment of the present disclosure, the position and number of the dynamic sampling points acquired in the dynamic-point sampling range may be determined according to actual design requirements, and the present disclosure will further introduce an exemplary process of acquiring the dynamic sampling points in subsequent content.

S430: acquiring a plurality of the fixed sampling points outside the dynamic-point sampling range.

In an embodiment of the present disclosure, the position and number of the fixed sampling points acquired outside the dynamic-point sampling range may be determined according to actual design requirements, and an embodiment of the present disclosure will further introduce an exemplary process of acquiring the fixed sampling points in subsequent content.

S440: dividing the first picture into a plurality of triangles by the fixed sampling points and the dynamic sampling points.

In this step, based on the plurality of fixed sampling points and the dynamic sampling points, the triangulation algorithm may be used to divide the first image into the plurality of triangles. For example, a specified fixed sampling point and a dynamic sampling point (such as two fixed sampling points and one dynamic sampling point, or one fixed sampling point and two dynamic sampling points) may be used as the vertices of the triangle, and the specified three dynamic sampling points may be used as the vertices of the triangle. Of course, in an embodiment of the present disclosure, other algorithms may also be used to divide the first image into the plurality of triangles, which will not be listed here.

S450: identifying a preset type of human body key point in the first picture.

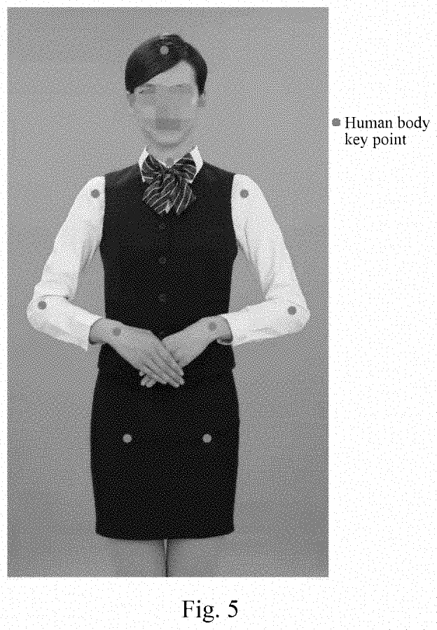

In an embodiment of the present disclosure, a plurality of types of human body key points may be defined in advance, such as ankle key points, waist key points, and neck key points. FIG. 5 shows an exemplary schematic distribution diagram of some human body key points provided by an embodiment of the present disclosure. In FIG. 5, each dot represents a type of human body key point.

In an embodiment of the present disclosure, at least one type of human body key point may be selected from a plurality of human body key points as the preset type of human body key point. For example, an ankle key point, a waist key point, and a neck key point may be defined as the preset types of human body key point. In step S450, the preset type of human body key point may be identified based on the character image in the first picture.

S460: rotating at least one of the sampling points by a preset angle based on at least one type of the human body key point by a preset angle to deform the at least a portion of the plurality of triangles in the first picture, to obtain the second picture.

In an embodiment of the present disclosure, using a human body key point determined in step S450 as a rotation center point, the at least one sampling point is rotated by the preset angle based on the rotation center point, so that the at least a portion of the plurality of triangles are deformed by changing the position of the at least one sampling point, and the first picture with at least a portion of the triangles being deformed is defined as the second picture. It may be understood that since at least a portion of the triangles in the second picture are different from the corresponding triangles in the first picture, the pose of the character in the second picture is different from the pose of the character in the first picture. In an embodiment of the present disclosure, a human body key point determined in step S450 may be used as a rotation center of the at least one sampling point, and the sampling point that needs to be rotated and its corresponding rotation angle may be determined according to actual design requirements. Using the human body key point as the rotation center of the at least one sampling point conforms to natural laws of human body movement, and may make the pose of a deformed human body image more natural.

In an embodiment of the present disclosure, in order to avoid large deformation of the background area in the second picture, only the position of the dynamic sampling point may be changed. Specifically, at least one dynamic sampling point may be rotated by the preset angle based on at least one type of the human body key point, so as to avoid deforming triangle(s) in the background area as much as possible, thereby avoiding the large deformation of the background area in the second picture, ensuring a visual effect of the picture.

The ankle key point (not shown in the figure), the waist key point and the neck key point as the preset types of human body key point are used as an example. First, the ankle key point is used as the rotation center, and all dynamic sampling points above the ankle key point are rotated by a first preset angle; then, the waist key point is used as the rotation center, all dynamic sampling points above the waist key point are rotated by a second preset angle; and finally the neck key point is used as the rotation center, all dynamic sampling points above the neck key point are rotated by a third preset angle. Finally, the second picture may be obtained.

S470: acquiring at least one intermediate picture between the first picture and the second picture, and generating the dynamic video of the character including the first picture, the second picture and the at least one intermediate picture.

Here, a description of step S470 may refer to the description of step S140, and detailed description thereof will be omitted.

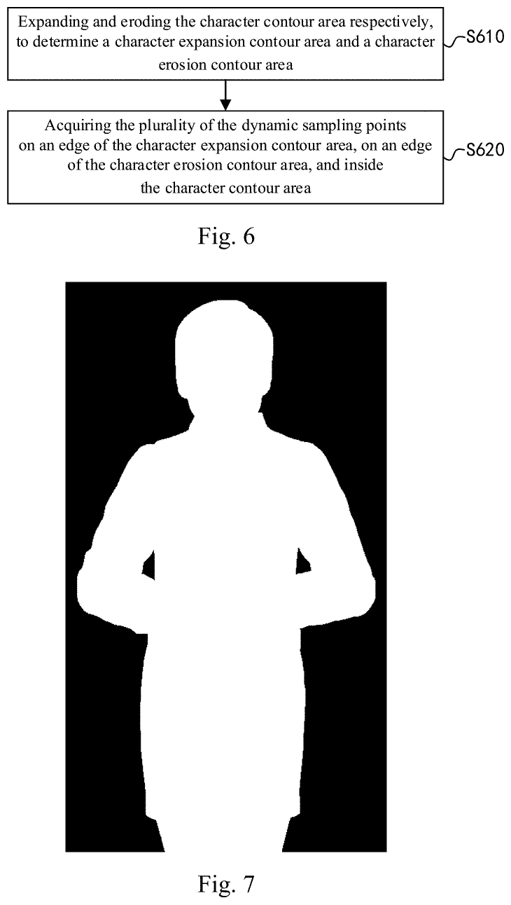

FIG. 6 shows a schematic flowchart of a method for determining dynamic-point sampling provided by an embodiment of the present disclosure, as shown in FIG. 6, the method may mainly include the following steps.

S610: expanding and eroding the character contour area respectively, to determine a character expansion contour area and a character erosion contour area.

In an embodiment of the present disclosure, expanding the character contour area refers to proportionally enlarging the character contour area, and the character expansion contour area obtained by enlarging may include the character contour area therein. Eroding the character contour area refers to scaling-down the character contour area, and the character erosion contour area obtained by the scaling-down may be completely included inside the character contour area.

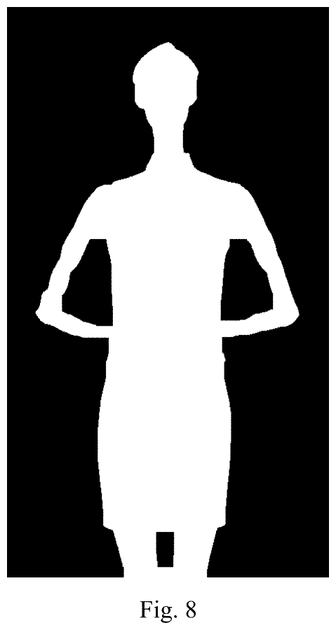

FIG. 7 shows a schematic diagram of a character expansion contour area determined in a first picture provided by an embodiment of the present disclosure, in which a black area represents the background area, and a white area represents the character expansion contour area. FIG. 8 shows a schematic diagram of a character erosion contour area determined in a first picture provided by an embodiment of the present disclosure, in which a black area represents the background area, and a white area represents the character erosion contour area.

It may be understood that the character expansion contour area in FIG. 7 is obtained by expanding the character contour area in FIG. 3, and the character expansion contour area may include the character contour area therein. The character erosion contour area in FIG. 8 is obtained by eroding the character contour area in FIG. 3, and the character erosion contour area may be completely included inside the character contour area.

S620: acquiring the plurality of the dynamic sampling points on an edge of the character expansion contour area, on an edge of the character erosion contour area, and inside the character contour area.

As described above, the character expansion contour area may include the character contour area therein, and the character erosion contour area may be completely included inside the character contour area. Therefore, dynamic sampling points on the edge of the character expansion contour area are all outside the edge of the character contour area, dynamic sampling points on the edge of the character erosion contour area are all inside the edge of the character contour area, and dynamic sampling points inside the character contour area are also inside the edge of the character contour area. That is, there is no dynamic sampling point on the edge of the character contour area.

In an embodiment of the present disclosure, the character expansion contour area may be used as the dynamic-point sampling range. Therefore, a plurality of the fixed sampling points may be acquired outside the character expansion contour area. That is, there is no fixed sampling point on the edge of the character contour area. When the first picture is divided into a plurality of triangles by the sampling points, the vertices of a triangle outside the character expansion contour area are a combination of fixed sampling points and dynamic sampling points. For example, the three vertices of the triangle are one fixed sampling point and two dynamic sampling points, or the three vertices of the triangle are two fixed sampling points and one dynamic sampling point.

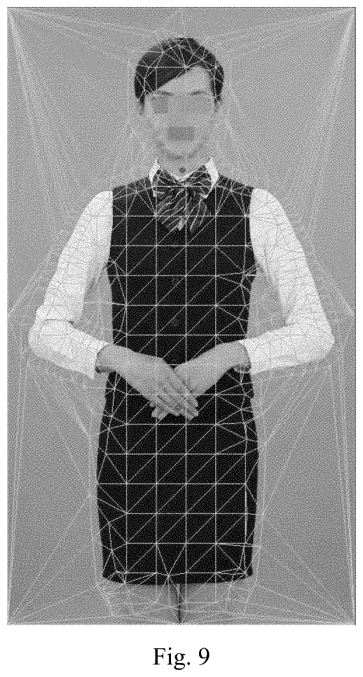

Of course, in order to further reduce the deformation degree of the triangle in the background area, the plurality of the fixed sampling points are acquired on an edge of the first picture. It may be understood that a triangle with fixed sampling points on the edge of the first picture as the vertices is located in the background area and has a large area. FIG. 9 shows an exemplary schematic distribution diagram of triangles in a first picture provided by an embodiment of the present disclosure. In FIG. 9, a circle formed by sampling points around the character image are dynamic sampling points on the edge of the character expansion contour area, 8 sampling points on the edge of the first picture are fixed sampling points, and triangles with fixed sampling points on the edge of the first picture as the vertices are located in the background area. When the position of each dynamic sampling point has an identical change degree, a deformation degree of a triangle located in the background area is smaller than that of a triangle inside the character image, thereby avoiding large deformation of the background area in the second picture, ensuring a visual effect of the picture.

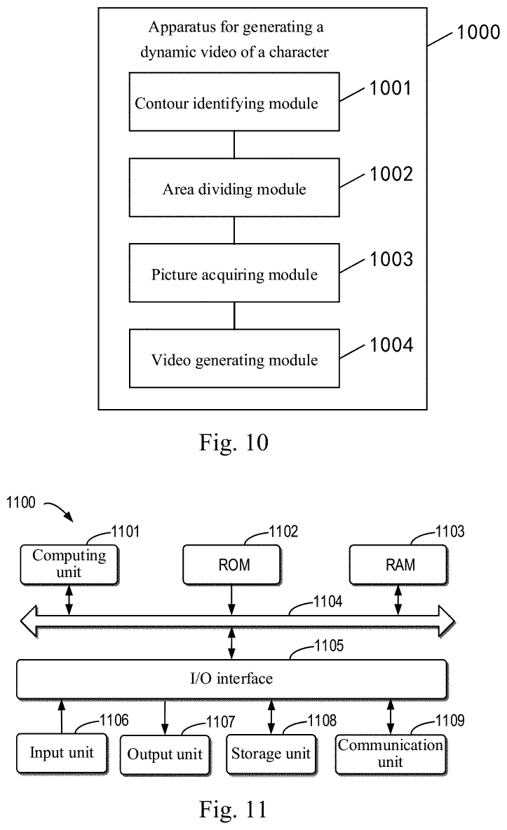

Based on the same principle as the above method for generating a dynamic video of a character, FIG. 10 shows a schematic structural diagram of an apparatus for generating a dynamic video of a character provided by an embodiment of the present disclosure. As shown in FIG. 10, the apparatus 1000 for generating a dynamic video of a character includes a contour identifying module 1001, an area dividing module 1002, a picture acquiring module 1003, and a video generating module 1004.

The contour identifying module 1001 is configured to identify a character contour area in a first picture containing a character image.

The area dividing module 1004 is configured to acquire a plurality of sampling points in the first picture based on the character contour area, and divide the first picture into a plurality of triangles by the sampling points.

The picture acquiring module 1003 is configured to deform at least a portion of the plurality of triangles in the first picture to obtain a second picture.

The video generating module 1004 is configured to acquire at least one intermediate picture between the first picture and the second picture, and generate the dynamic video of the character including the first picture, the second picture and the at least one intermediate picture.

In the apparatus for generating a dynamic video of a character provided by an embodiment of the present disclosure, a second picture that is different from the pose of the character in the first picture is first generated, and then an intermediate picture between the first picture and the second picture is generated to obtain the dynamic video of the character. The above process of generating a dynamic video of a character basically does not require human participation, which can save costs and improve the video generation efficiency.

In an embodiment of the present disclosure, the plurality of sampling points includes fixed sampling points and dynamic sampling points; and the area dividing module 1002, in acquiring a plurality of sampling points in the first picture based on the character contour area, is further configured to: determine a dynamic-point sampling range corresponding to the character contour area, and acquire a plurality of the dynamic sampling points within the dynamic-point sampling range; and acquire a plurality of the fixed sampling points outside the dynamic-point sampling range;

where the dynamic-point sampling range includes at least the character contour area, and any one of the dynamic sampling points is not on an edge of the character contour area.

In an embodiment of the present disclosure, the area dividing module 1002, in determining a dynamic-point sampling range corresponding to the character contour area, and acquiring a plurality of the dynamic sampling points within the dynamic-point sampling range, is further configured to: expand and erode the character contour area respectively, to determine a character expansion contour area and a character erosion contour area; and

acquire the plurality of the dynamic sampling points on an edge of the character expansion contour area, on an edge of the character erosion contour area, and inside the character contour area.

In an embodiment of the present disclosure, the area dividing module 1002, in acquiring a plurality of the fixed sampling points outside the dynamic-point sampling range, is further configured to: acquire the plurality of the fixed sampling points outside the character expansion contour area.

In an embodiment of the present disclosure, the area dividing module 1002, in acquiring a plurality of the fixed sampling points outside the dynamic-point sampling range, is further configured to: acquire the plurality of the fixed sampling points on a border of the first picture.

In an embodiment of the present disclosure, when the picture acquiring module 1003, deforming at least a portion of the plurality of triangles in the first picture to obtain a second picture, is further configured to: identify preset types of human body key points in the first picture; and rotate at least one of the sampling points by a preset angle based on at least one type of the human body key points to deform the at least a portion of the plurality of triangles in the first picture.

In an embodiment of the present disclosure, the plurality of sampling points include the fixed sampling points and the dynamic sampling points, and the picture acquiring module 1003, in rotating at least one of the sampling points by a preset angle based on at least one type of the human body key points, is further configured to: rotate at least one of the dynamic sampling points by the preset angle based on at least one type of the human body key points.

In an embodiment of the present disclosure, when the video generating module 1004, in acquiring at least one intermediate picture between the first picture and the second picture, is further configured to:

perform video frame insertion based on the first picture and the second picture to acquire the at least one intermediate picture between the first picture and the second picture.

It may be understood that the above modules of the apparatus for generating a dynamic video of a character in the embodiments of the present disclosure have the function of implementing the corresponding steps of the above method for generating a dynamic video of a character. The function may be implemented by hardware or by executing corresponding software by hardware. The hardware or software includes one or more modules corresponding to the above function. The above modules may be software and/or hardware, and the above modules may be implemented independently, or a plurality of modules may be integrated and implemented. For a functional description of each module of the apparatus for generating a dynamic video of a character, reference may be made to the corresponding description of the above method for generating a dynamic video of a character, and detailed description thereof will be omitted.

In the technical solution of the present disclosure, the acquisition, storage and application of the user personal information involved are all in accordance with the provisions of the relevant laws and regulations, and the public order and good customs are not violated.

According to an embodiment of the present disclosure, the present disclosure also provides an electronic device, a readable storage medium, and a computer program product.

FIG. 11 shows a schematic block diagram of an example electronic device that may be used to implement the method for generating a dynamic video of a character provided by embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 11, the electronic device 1100 includes a computing unit 1101, which may perform various appropriate actions and processing, based on a computer program stored in a read-only memory (ROM) 1102 or a computer program loaded from a storage unit 1108 into a random access memory (RAM) 1103. In the RAM 1103, various programs and data required for the operation of the electronic device 1100 may also be stored. The computing unit 1101, the ROM 1102, and the RAM 1103 are connected to each other through a bus 1104. An input/output (I/O) interface 1105 is also connected to the bus 1104.

A plurality of parts in the electronic device 1100 are connected to the I/O interface 1105, including: an input unit 1106, for example, a keyboard and a mouse; an output unit 1107, for example, various types of displays and speakers; the storage unit 1108, for example, a disk and an optical disk; and a communication unit 1109, for example, a network card, a modem, or a wireless communication transceiver. The communication unit 1109 allows the electronic device 1100 to exchange information/data with other devices over a computer network such as the Internet and/or various telecommunication networks.

The computing unit 1101 may be various general-purpose and/or dedicated processing components having processing and computing capabilities. Some examples of the computing unit 1101 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 1101 performs the various methods and processes described above, such as the method for generating a dynamic video of a character. For example, in some embodiments, the method for generating a dynamic video of a character may be implemented as a computer software program, which is tangibly included in a machine readable medium, such as the storage unit 1108. In some embodiments, part or all of the computer program may be loaded and/or installed on the electronic device 1100 via the ROM 1102 and/or the communication unit 1109. When the computer program is loaded into the RAM 1103 and executed by the computing unit 1101, one or more steps of the method for generating a dynamic video of a character described above may be performed. Alternatively, in other embodiments, the computing unit 1101 may be configured to perform the method for generating a dynamic video of a character by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output apparatus.

Program codes for implementing the method of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flowcharts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random-access memory (RAM), a read only memory (ROM), an erasable programmable read only memory (EPROM or flash memory), an optical fiber, a portable compact disk read only memory (CD-ROM), an optical memory device, a magnetic memory device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solution disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for generating a dynamic video of a character, the method comprising:
identifying a character contour area in a first picture containing a character image;
acquiring a plurality of sampling points in the first picture based on the character contour area, and dividing the first picture into a plurality of triangles by the sampling points;
deforming at least a portion of the plurality of triangles in the first picture to obtain a second picture; and
acquiring at least one intermediate picture between the first picture and the second picture, and generating the dynamic video of the character comprising the first picture, the second picture and the at least one intermediate picture.

2. The method according to claim 1, wherein the plurality of sampling points comprise fixed sampling points and dynamic sampling points; and acquiring a plurality of sampling points in the first picture based on the character contour area comprises:
determining a dynamic-point sampling range corresponding to the character contour area, and acquiring a plurality of the dynamic sampling points within the dynamic-point sampling range; and
acquiring a plurality of the fixed sampling points outside the dynamic-point sampling range;
wherein the dynamic-point sampling range comprises at least the character contour area, and any one of the dynamic sampling points is not on an edge of the character contour area.

3. The method according to claim 2, wherein determining a dynamic-point sampling range corresponding to the character contour area, and acquiring a plurality of the dynamic sampling points within the dynamic-point sampling range, comprises:
expanding and eroding the character contour area respectively, to determine a character expansion contour area and a character erosion contour area; and
acquiring the plurality of the dynamic sampling points on an edge of the character expansion contour area, on an edge of the character erosion contour area, and inside the character contour area.

4. The method according to claim 3, wherein acquiring a plurality of the fixed sampling points outside the dynamic-point sampling range, comprises: acquiring the plurality of the fixed sampling points outside the character expansion contour area.

5. The method according to claim 2, wherein acquiring a plurality of the fixed sampling points outside the dynamic-point sampling range comprises: acquiring the plurality of the fixed sampling points on a border of the first picture.

6. The method according to claim 1, wherein deforming at least a portion of the plurality of triangles in the first picture to obtain a second picture comprises:
identifying preset types of human body key points in the first picture; and
rotating at least one of the sampling points by a preset angle based on at least one type of the human body key points to deform at least a portion of the plurality of triangles in the first picture.

7. The method according to claim 6, wherein the plurality of sampling points comprise fixed sampling points and dynamic sampling points; and rotating at least one of the sampling points by a preset angle based on at least one type of the human body key points comprises:
rotating at least one of the dynamic sampling points by the preset angle based on at least one type of the human body key points.

8. The method according to claim 1, wherein acquiring at least one intermediate picture between the first picture and the second picture comprises:
performing video frame insertion based on the first picture and the second picture to acquire the at least one intermediate picture between the first picture and the second picture.

9. An apparatus for generating a dynamic video of a character, the apparatus comprising:
at least one processor; and
a memory storing instructions, wherein the instructions when executed by the at least one processor, cause the at least one processor to perform operations, the operations comprising:
identifying a character contour area in a first picture containing a character image;
acquiring a plurality of sampling points in the first picture based on the character contour area, and dividing the first picture into a plurality of triangles by the sampling points;
deforming at least a portion of the plurality of triangles in the first picture to obtain a second picture; and
acquiring at least one intermediate picture between the first picture and the second picture, and generate the dynamic video of the character comprising the first picture, the second picture and the at least one intermediate picture.

10. The apparatus according to claim 9, wherein the plurality of sampling points comprise fixed sampling points and dynamic sampling points; and the operations further comprise:
determining a dynamic-point sampling range corresponding to the character contour area, and acquiring a plurality of the dynamic sampling points within the dynamic-point sampling range; and
acquiring a plurality of the fixed sampling points outside the dynamic-point sampling range;
wherein the dynamic-point sampling range comprises at least the character contour area, and any one of the dynamic sampling points is not on an edge of the character contour area.

11. The apparatus according to claim 10, wherein the operations further comprise:
expanding and eroding the character contour area respectively, to determine a character expansion contour area and a character erosion contour area; and
acquiring the plurality of the dynamic sampling points on an edge of the character expansion contour area, on an edge of the character erosion contour area, and inside the character contour area.

12. The apparatus according to claim 11, wherein, the operations further comprise: acquiring the plurality of the fixed sampling points outside the character expansion contour area.

13. The apparatus according to claim 10, wherein the operations further comprise: acquiring the plurality of the fixed sampling points on a border of the first picture.

14. The apparatus according to claim 9, wherein the operations further comprise:
identifying preset types of human body key points in the first picture; and
rotating at least one of the sampling points by a preset angle based on at least one type of the human body key points to deform the at least a portion of the plurality of triangles in the first picture.

15. The apparatus according to claim 14, wherein the plurality of sampling points comprise fixed sampling points and dynamic sampling points, and the operations further comprise:
rotating at least one of the dynamic sampling points by the preset angle based on at least one type of the human body key points.

16. The apparatus according to claim 9, wherein the operations further comprise:
performing video frame insertion based on the first picture and the second picture to acquire the at least one intermediate picture between the first picture and the second picture.

17. A non-transitory computer readable storage medium storing computer instructions, wherein, the computer instructions are used to cause the computer to perform operations comprising:
identifying a character contour area in a first picture containing a character image;
acquiring a plurality of sampling points in the first picture based on the character contour area, and dividing the first picture into a plurality of triangles by the sampling points;
deforming at least a portion of the plurality of triangles in the first picture to obtain a second picture; and
acquiring at least one intermediate picture between the first picture and the second picture, and generating the dynamic video of the character comprising the first picture, the second picture and the at least one intermediate picture.

18. The non-transitory computer readable storage medium according to claim 17, wherein the plurality of sampling points comprise fixed sampling points and dynamic sampling points; and acquiring a plurality of sampling points in the first picture based on the character contour area, comprises:
determining a dynamic-point sampling range corresponding to the character contour area, and acquiring a plurality of the dynamic sampling points within the dynamic-point sampling range; and
acquiring a plurality of the fixed sampling points outside the dynamic-point sampling range;
wherein the dynamic-point sampling range comprises at least the character contour area, and any one of the dynamic sampling points is not on an edge of the character contour area.

19. The non-transitory computer readable storage medium according to claim 18, wherein determining a dynamic-point sampling range corresponding to the character contour area, and acquiring a plurality of the dynamic sampling points within the dynamic-point sampling range, comprises:
expanding and eroding the character contour area respectively, to determine a character expansion contour area and a character erosion contour area; and
acquiring the plurality of the dynamic sampling points on an edge of the character expansion contour area, on an edge of the character erosion contour area, and inside the character contour area.

20. The non-transitory computer readable storage medium according to claim 19, wherein acquiring a plurality of the fixed sampling points outside the dynamic-point sampling range, comprises: acquiring the plurality of the fixed sampling points outside the character expansion contour area.
